(19) United States
(12) Patent Application Publication
(10) Pub. No.: US 2025/0184627 A1
(43) Pub. Date: Jun. 5, 2025

(54) MULTIPLE PIXEL BINNING WITH GLOBAL SHUTTER OPERATION

(71) Applicant: Fairchild Imaging, Inc., San Jose, CA (US)

(72) Inventors: Xianmin Yi, Menlo Park, CA (US); Alexander Lu, San Jose, CA (US)

(21) Appl. No.: 18/525,093

(22) Filed: Nov. 30, 2023

(51) Int. Cl. H04N 25/46; H04N 23/667; H04N 25/532; H04N 25/771; H04N 25/78

(52) U.S. Cl. CPC H04N 25/46; H04N 25/532; H04N 25/771; H04N 25/78; H04N 23/667

(57) ABSTRACT

Structures are disclosed for a binned set of pixels (such as a 2×2 set of pixels) of a pixel array that shares a same readout circuit and can operate with a global shutter. The global shutter allows for greater charge storage from each pixel and for the charge from each of the binned pixels to be collected simultaneously. In an example, each of the binned pixels includes a photodetector, a transfer gate, and a storage gate. The storage gate of each binned pixel may be linked as part of a global shutter. The readout circuit can be coupled to the transfer gate of each of the binned pixels and includes its own second transfer gate that separates the pixels from a storage or sensing node. The photodetector signal on the sensing node can be amplified via a source follower component and ultimately read out to a column amplifier.

### BACKGROUND

Image sensors are widely used for a number of different applications across a large portion of the electromagnetic spectrum. Many image sensor designs use an array of sensors to capture light across a given area. Each sensor may be considered a single pixel of the sensor array, with the pixels arranged in any number of rows and columns. Each pixel includes some form of photodetector as well as a readout circuit to collect the charge from the photodetector in response to a light input. A number of non-trivial issues exist with regard to the design of pixel arrays for an image sensor.

### BRIEF DESCRIPTION OF THE DRAWINGS

FIG. 1 is a block diagram of an image sensor that uses a pixel array, in accordance with an embodiment of the present disclosure.

FIG. 2 is a block diagram illustrating componentry of a binned set of pixels of the pixel array of FIG. 1, in accordance with an embodiment of the present disclosure.

FIG. 3 is a schematic diagram illustrating the binned set of pixels of FIG. 2, in accordance with an embodiment of the present disclosure.

FIG. 4 is a timing diagram for various signals that control certain elements of the binned pixel circuit of FIG. 3, in accordance with an embodiment of the present disclosure.

FIG. 5 illustrates an example computing platform or apparatus that may include the image sensor of FIG. 1, in accordance with an embodiment of the present disclosure.

These and other features of the present embodiments will be understood better by reading the following detailed description, taken together with the figures herein described.

### DETAILED DESCRIPTION

Structures are disclosed for a binned set of pixels (e.g., such as a 2×2 set of pixels) of a pixel array that share a same readout circuit and can operate with a global shutter. The binned pixel design provides space-saving benefits on the chip and also improves the overall image quality. The global shutter allows for greater charge storage from each pixel and for the charge from each of the binned pixels to be collected together at the same time. According to some embodiments, each of the binned pixels includes a photodetector, its own transfer gate, and a storage gate. The storage gate of each binned pixel may be linked such that they all turn on and turn off together (e.g., global shutter operation). The readout circuit is coupled to the transfer gate of each of the binned pixels and includes its own second transfer gate that separates the pixels from a storage or sensing node. The photodetector signal on the sensing node can be amplified via a source follower component and ultimately read out to a column amplifier. The image sensor may be operated in a binning mode (e.g., all binned pixels transfer charge at the same time) or a non-binning mode (e.g., binned pixels transfer charge sequentially).

### General Overview

As previously noted, there a number of non-trivial issues that remain with respect to designing pixel arrays for an image sensor. For example, the charge from each pixel needs to be read out using a readout circuit having a given conversion gain and dynamic range. When hundreds or thousands of pixels (or more) are used in an array, this can pose a problem for fitting the elements required for so many readout circuits, especially when using capacitors to adjust conversion gain, given that capacitors tend to take up a relatively large amount of space on chip. Moreover, coupling multiple pixels to a given readout node can reduce conversion gain and dynamic range.

Thus, and in accordance with an embodiment of the present disclosure, techniques are disclosed for designing a pixel array having binned pixels that share a common readout circuit. The binned pixels can be arranged for global shutter operation to allow for simultaneous exposure and charge capture from all of the pixels of a given bin. The sensor array of pixels may be, for example, any type of CMOS image sensor designed to receive light for the purpose of generating an image from the light received via the sensor array, although other pixel-based imaging arrays may also benefit. The pixels may be binned, for instance, in a 2×2 array, so as to provide four pixels binned together with a common readout circuit, although other arrayed arrangements can be used as well. For example, fewer than four pixels (e.g., 1×1 array or 1×2 array) or more than four pixels (e.g., 3×3 array or 4×4 array) may be binned together with a common readout circuit. To this end, although four is used as an example throughout this disclosure, other examples may be configured differently. Each pixel may have its own photodetector, its own transfer gate, and its own storage gate, while the readout circuit includes a single additional transfer gate to pass charge from any of the binned pixels to a sensing node. In this manner, the sensing node is more directly coupled to one transfer gate (generally referred to herein as second transfer gate) rather than the many transfer gates of the binned pixels (generally referred to herein as first transfer gates), which may help improve conversion gain and dynamic range. The charge received at the sensing node from one or more photodetectors of the binned pixels may be used to generate a current signal that is ultimately fed to a column amplifier or other amplifier element before being converted into a digital signal via an analog-to-digital converter (ADC).

The storage gate of each pixel in a given bin may operate together such that charge is stored across the storage gates of each binned pixel at the same time and the charge is released from the storage gates of each binned pixel at the same time. Due to the presence of the individual first transfer gates at each binned pixel, the global shutter operation of the storage gates can be used in either a binning mode (e.g., first transfer gates transfer the charge from the binned pixels at the same time) or a non-binning mode (e.g., first transfer gates sequentially transfer charge from the binned pixels). According to some embodiments, the image sensor yields the same high conversion gain and low read noise during low light situations when operated in the binning mode compared to the non-binning mode.

According to an example embodiment, an image sensor includes at least two pixels with each pixel of the at least two pixels including a photodetector, a corresponding storage gate coupled to the photodetector, and a corresponding first transfer gate coupled to the corresponding storage gate. The image sensor further includes a second transfer gate having an input coupled to an output of each first transfer gate of each of the at least two pixels, and a control field effect transistor (FET). A gate of the control FET is configured to receive charge from an output of the second transfer gate.

According to another example embodiment, an image sensor includes a pixel array having at least one column of addressable pixels, a readout circuit, a column amplifier coupled to the readout circuit, an analog-to-digital converter (ADC) coupled to the column amplifier, and a processor coupled to the ADC. The at least one column of addressable pixels includes at least two pixels with each pixel of the at least two pixels including a photodetector, a storage gate coupled to the photodetector, and a first transfer gate coupled to the storage gate. The readout circuit includes a second transfer gate having an input coupled to an output of each first transfer gate of each of the at least two pixels, and a control FET. A gate of the control FET is configured to receive charge from an output of the second transfer gate.

According to another example embodiment, a CMOS image sensor (CIS) includes four pixels with each pixel of the four pixels including a photodetector, a storage gate coupled to the photodetector, and a first transfer gate coupled to the storage gate. The CIS further includes a second transfer gate having a single input coupled to an output of each first transfer gate of each of the four pixels, and a control FET. A gate of the control FET is configured to receive charge from an output of the second transfer gate. The four pixels may be arranged, for instance, in a 2×2 grid, although other grids can be used.

The description uses the phrases “in an embodiment” or “in embodiments,” which may each refer to one or more of the same or different embodiments. Furthermore, the terms “comprising,” “including,” “having,” and the like, as used with respect to embodiments of the present disclosure, are synonymous.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed, and/or described operations may be omitted in additional embodiments.

### System Architecture

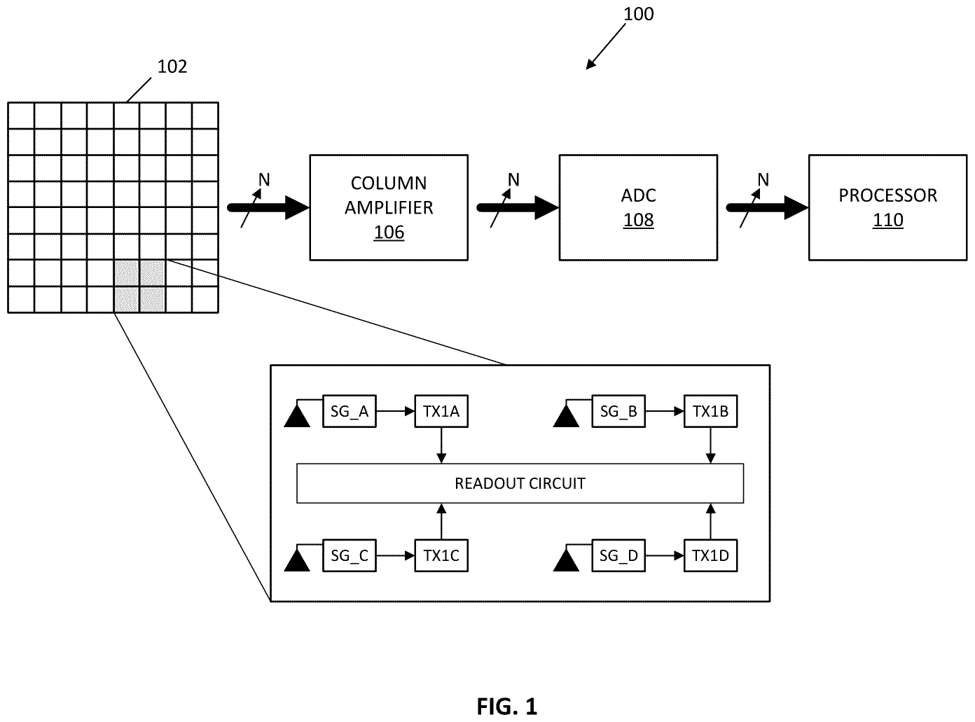

FIG. 1 is a block diagram of an example image sensor 100, according to some embodiments. Image sensor 100 may represent or be an integral part of a CMOS image sensing camera or other type of imaging device. In some embodiments, image sensor 100 may be configured for capturing different portions of the electromagnetic spectrum, such as visible light, ultraviolet radiation, infrared radiation, or x-rays, to name a few examples. Image sensor 100 may include a pixel array 102, a column amplifier 106, an ADC 108, and a processor 110. Each of the illustrated components may be included together on same printed circuit board (PCB) or together in a single chip package (e.g., a system-in-package or system-on-chip). In some other embodiments, any one or more of the elements may be provided in a separate chip package and/or on separate PCBs.

According to some embodiments, pixel array 102 includes a plurality of pixels arranged in a row-column format. Each pixel of pixel array 102 may have a similar architecture that includes at least a photodetector, a storage gate, and a transfer gate. The photo detection area of each pixel on which incident radiation may impinge may vary from one embodiment to the next, but in some example cases has a physical size of around 1 μm×1 μm up to around 5 μm×5 μm. Likewise, the shape and lensing (if present) of the photo detection area (e.g., photo diode) can also vary from one example to the next, depending on factors such as desired fill factor of the array. According to some embodiments, each row of pixels may be coupled together via a common row-select line (e.g., a wordline), to provide separately addressable rows of pixels.

As shown in the blown-out section, a group of pixels may be binned together to share a common readout circuit. In the illustrated example, four pixels in a 2×2 array have each of their transfer gates (TX1A-TX1D) coupled to a common readout circuit to read the charge from each photodetector of each of the binned pixels. As noted above, any number and arrangement of pixels on pixel array 102 can be binned together to share a common readout circuit. Note that each of the binned pixels also includes its own storage gate (SG_A-SG_D) coupled between its photo diode and transfer gate (TX1A-TX1D). According to some embodiments, storage gates (SG_A-SG_D) operate in unison with one another as part of a global shutter arrangement. Accordingly, charge may be stored at storage gates (SG_A-SG_D) across each of the binned pixels and transferred onto the corresponding transfer gates (TX1A-TX1D) at the same time.

According to some embodiments, the outputs from N different columns of pixels are received by column amplifier 106. According to some embodiments, column amplifier 106 represents N separate column amplifiers with a given column amplifier configured to receive the output from a corresponding column of pixels (or a corresponding column of binned pixels) from pixel array 102. In this way, a given row of pixels from pixel array 102 (or a row of binned pixels) can be selected via a row-select line and simultaneously read out via the N column amplifiers 106. According to some embodiments, column amplifier 106 may include any type of amplifier configuration, such as any number of source follower FETs or operational amplifiers. In some embodiments, a single column amplifier 106 may be used in conjunction with a multiplexer to receive each of the N column outputs from pixel array 102.

According to some embodiments, binned groups of pixels (such as the illustrated 2×2 array of pixels coupled to a common readout circuit) are arranged in rows and columns across pixel array 102. In this way, the total number of column amplifiers may be reduced as a single column amplifier may read from a given column of binned pixels as opposed to a single column of pixels.

According to some embodiments, the output(s) from column amplifier 106 is/are received by ADC 108. As noted above, ADC 108 may represent N different ADCs with a given ADC configured to receive the output from a corresponding column amplifier 106. ADC 108 may be any known type of ADC without limitation.

Processor 110 may be configured to receive the digitized signal from ADC 108 (or N digitized signals across N ADCs) and perform any number of operations with the signal(s). For example, processor 110 may receive the signal data from a given row of pixels (or row of binned pixels) of pixel array 102 and use the signal data to create an image or a portion of an image captured via pixel array 102. As used herein, the term “processor” may refer to any device or portion of a device that processes electronic data from registers and/or memory to transform that electronic data into other electronic data that may be stored in registers and/or memory. Processor 110 may include one or more digital signal processors (DSPs), application-specific integrated circuits (ASICs), central processing units (CPUs), graphics processing units (GPUs), cryptoprocessors (specialized processors that execute cryptographic algorithms within hardware), server processors, custom-built semiconductor, or any other suitable processing devices.

### Binned Pixel Design

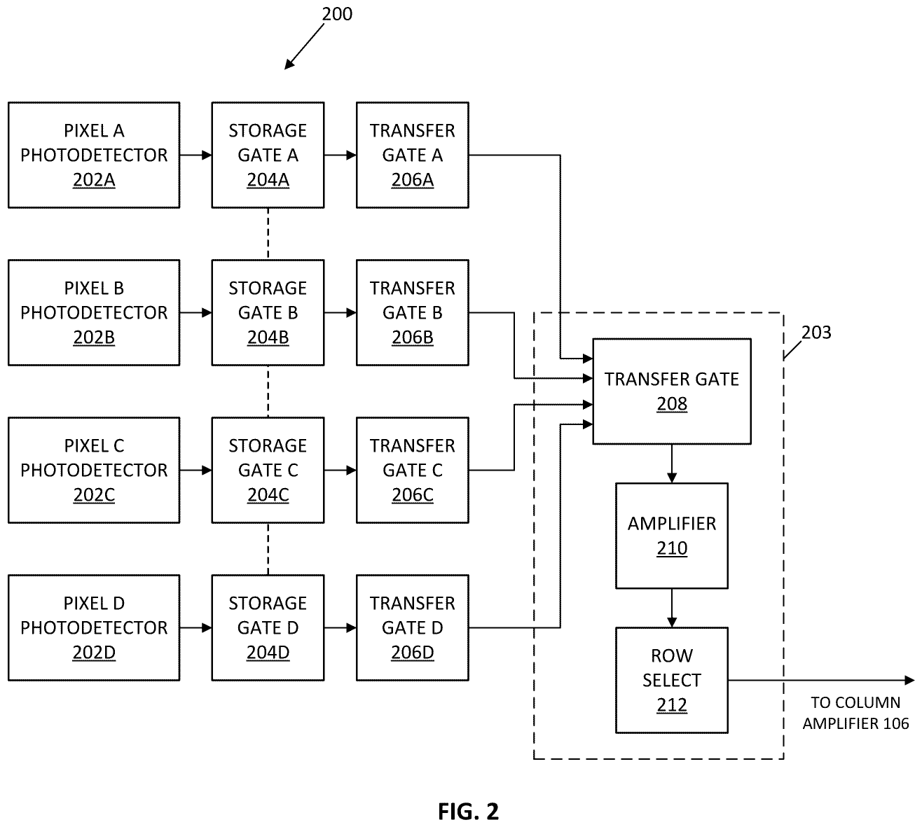

FIG. 2 illustrates a block diagram of a group of binned pixels 200 from pixel array 102 that includes four binned pixels with each of the four pixels coupled to a readout circuit 203, according to some embodiments. Each of the four binned pixels includes a photodetector 202A-202D, a corresponding storage gate 204A-204D, and a corresponding transfer gate 206A-206D. Photodetector 202A-202D may include any type of photosensitive design, such as a PN diode. Note that the term pixel as used herein may refer to a functional pixel circuit and not just the photo detection area of a given pixel.

According to some embodiments, readout circuit 203 includes a transfer gate 208 coupled to an output of each of the transfer gates 206A-206D of the four pixels. Transfer gate 208 acts like a gatekeeper to the charge generated by any or all of the photodetectors 202A-202D in response to a light input. In some embodiments, transfer gate 208 may include a single field effect transistor (FET), such as a p-doped or n-doped metal oxide semiconductor device (PMOS or NMOS). In some embodiments, transfer gate 208 is followed by a potential barrier, such as a PN diode, to allow for charge pumping via transfer gate 208.

Transfer gate 208 is configured to allow charge from any one of the photodetectors 202A-202D to pass on to a sensing node. According to some embodiments, the sensing node is further coupled to an amplifier 210, which generates an output signal. Amplifier 210 may be implemented as a single source-follower NMOS or PMOS device, or as an operational amplifier.

According to some embodiments, a row select switch 212 is included within readout circuit 203. Row select switch 212 may have a gate or select input that is coupled to a common row-line (e.g., a wordline) with other pixels (or binned pixels) of the same row. Accordingly, when the current row is activated to read out from, row select switch 212 is activated and turned on to read out the output signal to column amplifier 106. When the current row is not selected, row select switch 212 is not active and no signal is read out to column amplifier 106. Row select switch 212 may be implemented, for example, as an NMOS or PMOS device with the row-line coupled to the gate of the NMOS or PMOS device.

According to some embodiments, each of storage gates 204A-204D is linked together to operate as one (as identified by the dashed line between them). In this way, storage gates 204A-204D operate under a global shutter scheme to pass on the stored charge from each photodetector 202A-202D of the binned group of pixels at the same time. Transfer gates 206A-206D may then be configured to pass the charge on to transfer gate 208 in different ways. For example, in a binning mode of operation, all transfer gates 206A-206D activate at the same time to transfer charge from all binned pixels to transfer gate 208 at substantially the same time. In another example, transfer gates 206A-206D activate one at a time in a non-binning mode of operation to transfer charge from a particular pixel to transfer gate 208 at any given time. This transfer of charge may occur sequentially (e.g., pixel A transfers charge followed by pixel B, etc.) or in any other order.

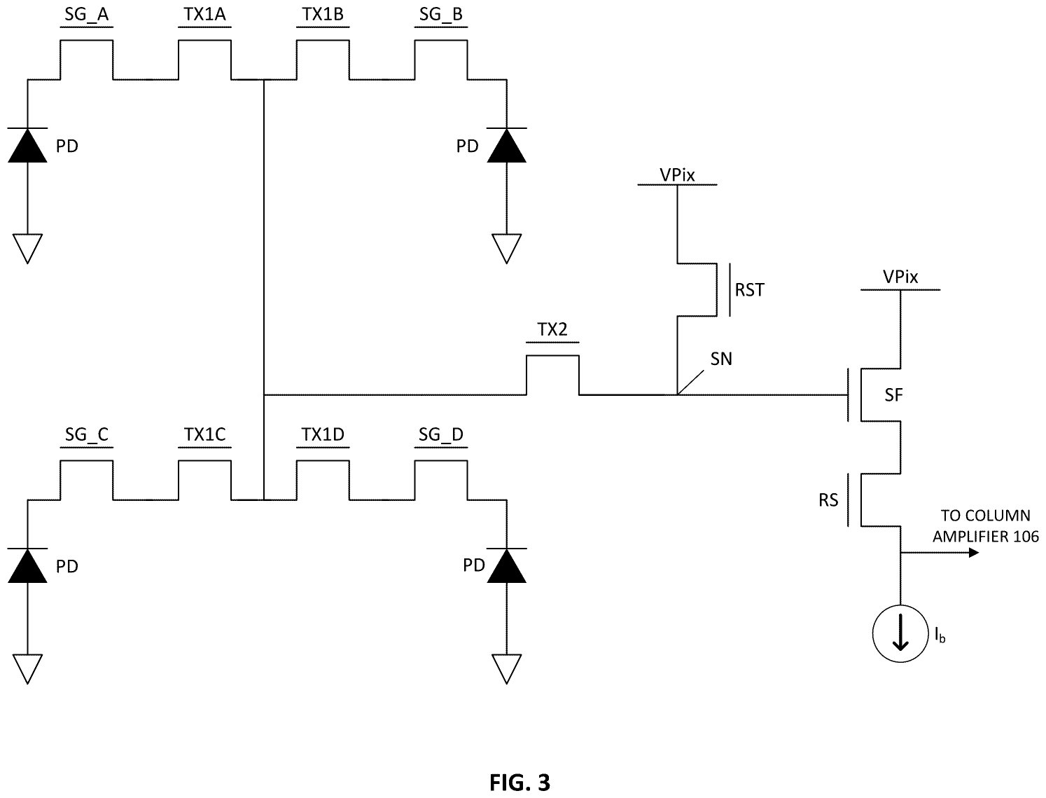

FIG. 3 illustrates an example circuit schematic of a given group of binned pixels from pixel array 102 along with a shared readout circuit, according to some embodiments. Each of the illustrated FETs may be either an NMOS or PMOS device depending on the layout. Additionally, in some embodiments, any of the FETs can be replaced with other transistor architectures, such as a bipolar junction transistor (BJT). According to some embodiments, the pixel readout circuit includes a current source I_{b} to provide a bias current for operating a source follower amplifier SF.

According to some embodiments, four pixels have been coupled to a single transfer gate TX2 of the readout circuit. In more detail, each of the four pixels includes a photodetector PD, a storage gate (SG_A-SG_D), and a first transfer gate (any of TX1A-TX1D). According to some embodiments, charge is received at second transfer gate TX2 from all pixels simultaneously (e.g., first transfer gates TX1A-TX1D are activated at the same time). According to some embodiments, charge is received from only one pixel at any given time such that only one of first transfer gates TX1A-TX1D is active at any given time to access the charge from the corresponding photodetector PD.

Light impinges upon each of the photodetectors PD where it is converted into electrical charge that can flow as a photocurrent. According to some embodiments, this charge is stored within storage gates SG_A-SG_D across the pixels. Each storage gate SG_A-SG_D may be a MOSFET having a first terminal coupled to the photodetector PD to receive charge from the corresponding photodetector PD and a second terminal coupled to the corresponding first transfer gate TX1A-TX1D. The first and second terminals may be source or drain regions of the transistor.

According to some embodiments, the first terminal of a given storage gate (e.g., coupled to the photodetector) has a higher threshold voltage compared to the second terminal of the given storage gate. In some examples, the threshold voltage at the second terminal is less than 0 V. The difference in threshold voltage at different ends of the transistor gate allow for storage gates SG_A-SG_D to have a large charge storage capacity. Additionally, storage gates SG_A-SG_D have a larger area under the gate compared to the corresponding first transfer gates TX1A-TX1D, according to some embodiments. For example, a given storage gate SG_A-SG_D may have a gate length between about 5 μm and about 7 μm while the corresponding first transfer gate TX1A-TX1D may have a gate length between about 0.3 μm and about 0.5 μm. In some cases, storage gates SG_A-SG_D have a gate length that is at least 10 times greater than the gate length of the corresponding first transfer gates TX1A-TX1D. The width of storage gates SG_A-SG_D may be substantially similar to its length (e.g., within 0.5 μm), providing a square-like W/L ratio. In some embodiments, the widths of storage gates SG_A-SG_D and first transfer gates TX1A-TX1D may be about the same (e.g., within 0.5 μm).

According to some embodiments, each of storage gates SG_A-SG_D may be turned on at substantially the same time to transfer the stored charge onto the corresponding first transfer gates TX1A-TX1D. Once the charge is held at each of first transfer gates TX1A-TX1D, the charge may be transferred from all pixels at once to second transfer gate TX2 (e.g., binning mode). TX2 may then be turned on to transfer the combined charge from all binned pixels onto sensing node SN. In another example, only one of first transfer gates TX1A-TX1D is turned on at any given time (e.g., non-binning mode) to transfer charge from the corresponding pixel to second transfer gate TX2 (e.g., binning mode). TX2 may then be turned on to transfer the charge from the corresponding pixel onto sensing node SN.

In any of the aforementioned modes of operation (e.g., binning or non-binning modes), storage gates SG_A-SG_D operate together in a global shutter scheme and the stored potential at sensing node SN activates the source follower amplifier SF to produce an output signal to send to column amplifier 106. Source follower amplifier SF may be a single FET device or any other amplifier structure, such as an operational amplifier. Source follower amplifier SF may be powered, for example, via rail power VPix between about 2 V and about 2.5 V or other suitable rail voltage. The output signal produced from source follower amplifier SF can only be sent on to column amplifier 106 if the row select switch RS is biased on. According to some such examples, all pixels (or binned pixels) in a given row of pixel array 102 will share a same row select line (e.g., a word line) that couples with the gate of row select switch RS. If row select switch RS is biased off, then the current pixel (or binned set of pixels) is part of a row that is not currently being read from and no signal will be sent on to column amplifier 106 from the current pixel (or binned set of pixels).

According to some embodiments, the potential at sensing node SN can be reset to a baseline or reference value via a reset switch RST. When reset switch RST is biased on, the rail voltage VPix is applied to at least sensing node SN, thus overriding whatever charge had been there from any of the photodetectors PD.

### Timing Diagram for Global Shutter Operation of Binned Pixels

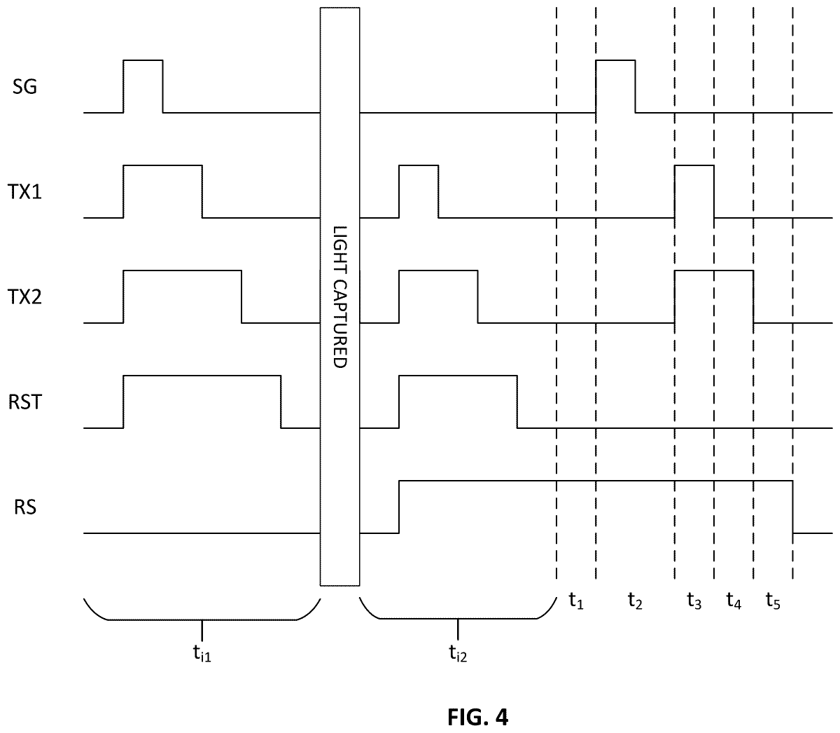

FIG. 4 provides an example timing diagram for various control signals during global shutter operation of binned pixels. It should be noted that in the timing diagram, TX1 may refer to each of the first transfer gates from each of the binned pixels (e.g., binning mode) or it may refer to only one of the first transfer gates from one of the binned pixels (e.g., non-binning mode). According to some embodiments, SG refers to each of the storage gates from each of the binned pixels (e.g., SG_A-SG_D).

According to some embodiments, an initialization time period tᵢ₁ may be used to reset the potential at various nodes around the circuit before the capturing of light occurs. During first initialization time period tᵢ₁, RST is biased on while each of SG, TX1, and TX2 are also biased on for at least one clock cycle. During this time, all nodes coupled to SG, TX1, and TX2 are reset with the rail voltage VPix. According to some embodiments, the various switches are then shut off in a sequence with SG being biased off first, followed by TX1, then TX2, and RST being biased off last. During this process, row select RS may be biased off since no reads are occurring from the pixels during this time.

According to some embodiments, a second initialization period tᵢ₂ may be used after light has been captured from the photodiodes of the binned pixels. During second initialization time period tᵢ₂, RST is biased on while both TX1 and TX2 are also biased on for at least one clock cycle. During this time, all nodes coupled to TX1 and TX2 are reset with the rail voltage VPix. Note that unlike first initialization time period to, the nodes between the photodetectors PD and storage gates SG_A-SG_D are not reset as the storage gates SG_A-SG_D now hold charge from the received light. According to some embodiments, the various switches are then shut off in a sequence with TX1 being biased off first, followed by TX2, and finally RST. During this process, row select RS may be biased on to begin reading baseline values from any of the nodes in the circuit.

After the initialization processes, row select RS continues to be biased on at a first time period t₁ and a baseline reading is captured of the potential at sensing node SN. At a second time period t₂, a global shutter signal turns on all storage gates SG_A-SG_D for at least one clock cycle to transfer charge from the storage gates SG_A-SG_D to the corresponding first transfer gates TX1A-TX1D. At a third time period t₃, the photodetector charge from either a single pixel or from all of the binned pixels is released onto sensing node SN by biasing on both TX1 and TX2.

At a fourth time period t₄, TX1 is biased off but TX2 remains biased on to ensure that any photodetector charge remaining on any of the lines between TX1A-TX1D and TX2 is released onto sensing node SN. At a fifth time period t₅, TX2 is biased off and a reading is captured of the charge from sensing node SN. According to some embodiments, At any time after the fifth time period t₅, RST can be biased on to reset the potential at sensing node SN back to a baseline rail voltage of VPix. In examples where the non-binning mode is used, the operations described in the third, fourth, and fifth time periods are repeated for any number of binned pixels.

According to some embodiments, the baseline readings are compared to the signal readings to capture the difference associated with the amount of light impinging upon the photodetectors PD of the binned pixels. For example, the baseline reading captured at time period t₁ is compared to the signal reading captured at time period t₅.

### Example Computing Platform

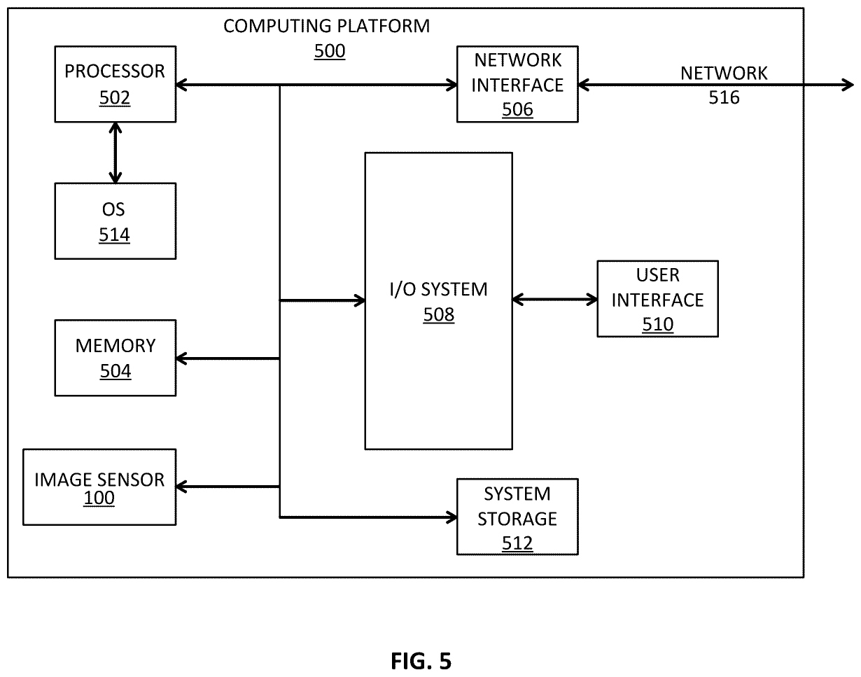

FIG. 5 illustrates an example computing platform 500 that interfaces with image sensor 100, configured in accordance with certain embodiments of the present disclosure. In some embodiments, computing platform 500 may host, or otherwise be incorporated into a personal computer, workstation, server system, laptop computer, ultra-laptop computer, tablet, touchpad, portable computer, handheld computer, palmtop computer, personal digital assistant (PDA), cellular telephone, combination cellular telephone and PDA, smart device (for example, smartphone or smart tablet), mobile internet device (MID), messaging device, data communication device, imaging device, wearable device, embedded system, and so forth. Any combination of different devices may be used in certain embodiments. Computing platform 500 may host a controlled area network (CAN) used on board a vehicle. In some embodiments, computing platform 500 represents one system in a network of systems coupled together via a CAN bus.

In some embodiments, computing platform 500 may comprise any combination of a processor 502, a memory 504, image sensor 100, a network interface 506, an input/output (I/O) system 508, a user interface 510, and a storage system 512. In some embodiments, one or more components of image sensor 100 are implemented as part of processor 502. As can be further seen, a bus and/or interconnect is also provided to allow for communication between the various components listed above and/or other components not shown. Computing platform 500 can be coupled to a network 516 through network interface 506 to allow for communications with other computing devices, platforms, or resources. Other componentry and functionality not reflected in the block diagram of FIG. 5 will be apparent in light of this disclosure, and it will be appreciated that other embodiments are not limited to any particular hardware configuration.

Processor 502 can be any suitable processor and may include one or more coprocessors or controllers to assist in control and processing operations associated with computing platform 500. In some embodiments, processor 502 may be implemented as any number of processor cores. The processor (or processor cores) may be any type of processor, such as, for example, a micro-processor, an embedded processor, a digital signal processor (DSP), a graphics processor (GPU), a network processor, a field programmable gate array or other device configured to execute code. The processors may be multithreaded cores in that they may include more than one hardware thread context (or “logical processor”) per core.

Memory 504 can be implemented using any suitable type of digital storage including, for example, flash memory and/or random-access memory (RAM). In some embodiments, memory 504 may include various layers of memory hierarchy and/or memory caches as are known to those of skill in the art. Memory 504 may be implemented as a volatile memory device such as, but not limited to, a RAM, dynamic RAM (DRAM), or static RAM (SRAM) device. Storage system 512 may be implemented as a non-volatile storage device such as, but not limited to, one or more of a hard disk drive (HDD), a solid-state drive (SSD), a universal serial bus (USB) drive, an optical disk drive, tape drive, an internal storage device, an attached storage device, flash memory, battery backed-up synchronous DRAM (SDRAM), and/or a network accessible storage device. In some embodiments, storage system 512 may comprise technology to increase the storage performance enhanced protection for valuable digital media when multiple hard drives are included.

Processor 502 may be configured to execute an Operating System (OS) 514 which may comprise any suitable operating system, such as Google Android (Google Inc., Mountain View, CA), Microsoft Windows (Microsoft Corp., Redmond, WA), Apple OS X (Apple Inc., Cupertino, CA), Linux, or a real-time operating system (RTOS). As will be appreciated in light of this disclosure, the techniques provided herein can be implemented without regard to the particular operating system provided in conjunction with computing platform 500, and therefore may also be implemented using any suitable existing or subsequently developed platform.

Network interface 506 can be any appropriate network chip or chipset which allows for wired and/or wireless connection between other components of computing platform 500 and/or network 516, thereby enabling computing platform 500 to communicate with other local and/or remote computing systems, servers, cloud-based servers, and/or other resources. Wired communication may conform to existing (or yet to be developed) standards, such as, for example, Ethernet. Wireless communication may conform to existing (or yet to be developed) standards, such as, for example, cellular communications including LTE (Long Term Evolution), Wireless Fidelity (Wi-Fi), Bluetooth, and/or Near Field Communication (NFC). Exemplary wireless networks include, but are not limited to, wireless local area networks, wireless personal area networks, wireless metropolitan area networks, cellular networks, and satellite networks.

I/O system 508 may be configured to interface between various I/O devices and other components of computing platform 500. I/O devices may include, but not be limited to, a user interface 510. User interface 510 may include devices (not shown) such as a display element, touchpad, keyboard, mouse, and speaker, etc. I/O system 508 may include a graphics subsystem configured to perform processing of images for rendering on a display element. Graphics subsystem may be a graphics processing unit or a visual processing unit (VPU), for example. An analog or digital interface may be used to communicatively couple graphics subsystem and the display element. For example, the interface may be any of a high-definition multimedia interface (HDMI), DisplayPort, wireless HDMI, and/or any other suitable interface using wireless high-definition compliant techniques. In some embodiments, the graphics subsystem could be integrated into processor 502 or any chipset of computing platform 500.

It will be appreciated that in some embodiments, the various components of the computing platform 500 may be combined or integrated in a system-on-a-chip (SoC) architecture. In some embodiments, the components may be hardware components, firmware components, software components or any suitable combination of hardware, firmware, or software.

In various embodiments, computing platform 500 may be implemented as a wireless system, a wired system, or a combination of both. When implemented as a wireless system, computing platform 500 may include components and interfaces suitable for communicating over a wireless shared media, such as one or more antennae, transmitters, receivers, transceivers, amplifiers, filters, control logic, and so forth. An example of wireless shared media may include portions of a wireless spectrum, such as the radio frequency spectrum and so forth. When implemented as a wired system, computing platform 500 may include components and interfaces suitable for communicating over wired communications media, such as input/output adapters, physical connectors to connect the input/output adaptor with a corresponding wired communications medium, a network interface card (NIC), disc controller, video controller, audio controller, and so forth. Examples of wired communications media may include a wire, cable metal leads, printed circuit board (PCB), backplane, switch fabric, semiconductor material, twisted pair wire, coaxial cable, fiber optics, and so forth.

### Further Example Embodiments

The following examples pertain to further embodiments, from which numerous permutations and configurations will be apparent.

Example 1 is an image sensor that includes at least two pixels with each pixel of the at least two pixels including a photodetector, a corresponding storage gate coupled to the photodetector, and a corresponding first transfer gate coupled to the corresponding storage gate. The image sensor further includes a second transfer gate having an input coupled to an output of each first transfer gate of each of the at least two pixels, and a control field effect transistor (FET). A gate of the control FET is configured to receive charge from an output of the second transfer gate.

Example 2 includes the image sensor of Example 1, wherein the first transfer gate of each of the at least two pixels is a FET and the storage gate of each of the at least two pixels is a FET.

Example 3 includes the image sensor of Example 2, wherein a length of the storage gate FET of each of the at least two pixels is higher than a length of the transfer gate FET of each of the at least two pixels.

Example 4 includes the image sensor of Example 3, wherein the length of the storage gate FET of each of the at least two pixels is at least 10 times higher than the length of the transfer gate FET of each of the at least two pixels.

Example 5 includes the image sensor of any one of Examples 2-4, wherein the storage gate of each of the at least two pixels has a first terminal coupled to the corresponding photodetector and a second terminal coupled to the corresponding first transfer gate, the first terminal having a higher threshold voltage compared to the second terminal.

Example 6 includes the image sensor of Example 5, wherein the second terminal has a negative threshold voltage.

Example 7 includes the image sensor of any one of Examples 1-6, further comprising a reset switch coupled to the output of the second transfer gate.

Example 8 includes the image sensor of any one of Examples 1-7, wherein the at least two pixels comprises four pixels arranged in a 2×2 grid.

Example 9 is an imaging system that includes the image sensor of any one of Examples 1-8.

Example 10 is an image sensor that includes a pixel array having at least one column of addressable pixels and a readout circuit. The at least one column of addressable pixels includes at least two pixels with each pixel of the at least two pixels including a photodetector, a storage gate coupled to the photodetector, and a first transfer gate coupled to the storage gate. The readout circuit includes a second transfer gate having an input coupled to an output of each first transfer gate of each of the at least two pixels and a control field effect transistor (FET). A gate of the control FET is configured to receive charge from an output of the second transfer gate.

Example 11 includes the image sensor of Example 10, wherein the first transfer gate of each of the at least two pixels is a FET and the storage gate of each of the at least two pixels is a FET.

Example 12 includes the image sensor of Example 11, wherein a length of the storage gate FET of each of the at least two pixels is higher than a length of the corresponding transfer gate FET of each of the at least two pixels.

Example 13 includes the image sensor of Example 12, wherein the length of the storage gate FET of each of the at least two pixels is at least 10 times higher than the length of the transfer gate FET of each of the at least two pixels.

Example 14 includes the image sensor of any one of Examples 11-13, wherein the storage gate of each of the at least two pixels has a first terminal coupled to the corresponding photodetector and a second terminal coupled to the corresponding first transfer gate, the first terminal having a higher threshold voltage compared to the second terminal.

Example 15 includes the image sensor of Example 14, wherein the second terminal has a negative threshold voltage.

Example 16 includes the image sensor of any one of Examples 10-15, further comprising a reset switch coupled to the output of the second transfer gate.

Example 17 includes the image sensor of any one of Examples 10-16, wherein the at least two pixels comprises four pixels arranged in a 2×2 grid.

Example 18 is an imaging system that includes the image sensor of any one of Examples 10-17, a column amplifier coupled to the readout circuit, an analog-to-digital converter (ADC) coupled to the column amplifier, and a processor coupled to the ADC.

Example 19 is a CMOS image sensor (CIS) that includes four pixels with each pixel of the four pixels including a photodetector, a storage gate coupled to the photodetector, and a first transfer gate coupled to the storage gate. The CIS further includes a second transfer gate having a single input coupled to an output of each first transfer gate of each of the four pixels, and a control field effect transistor (FET). A gate of the control FET is configured to receive charge from an output of the second transfer gate.

Example 20 includes the CIS of Example 19, wherein the first transfer gate of each of the four pixels is a FET and the storage gate of each of the four pixels is a FET.

Example 21 includes the CIS of Example 20, wherein a length of the storage gate FET of each of the four pixels is higher than a length of the transfer gate FET of each of the four pixels.

Example 22 includes the CIS of Example 21, wherein the length of the storage gate FET of each of the four pixels is at least 10 times higher than the length of the transfer gate FET of each of the four pixels.

Example 23 includes the CIS of any one of Examples 20-22, wherein the storage gate of each of the four pixels has a first terminal coupled to the corresponding photodetector and a second terminal coupled to the corresponding first transfer gate, the first terminal having a higher threshold voltage compared to the second terminal.

Example 24 includes the CIS of Example 23, wherein the second terminal has a negative threshold voltage.

Example 25 includes the CIS of any one of Examples 19-24, further comprising a reset switch coupled to the output of the second transfer gate.

Example 26 includes the CIS of any one of Examples 19-25, wherein the four pixels are arranged in a 2×2 grid.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future-filed applications claiming priority to this application may claim the disclosed subject matter in a different manner and generally may include any set of one or more limitations as variously disclosed or otherwise demonstrated herein.

What is claimed is:

1. An image sensor, comprising:
at least two pixels with each pixel of the at least two pixels including a photodetector, a storage gate coupled to the photodetector, and a first transfer gate coupled to the storage gate;
a second transfer gate having an input coupled to an output of each first transfer gate of each of the at least two pixels; and
a control field effect transistor (FET), wherein a gate of the control FET is configured to receive charge from an output of the second transfer gate.

2. The image sensor of claim 1, wherein the first transfer gate of each of the at least two pixels is a FET and the storage gate of each of the at least two pixels is a FET.

3. The image sensor of claim 2, wherein a length of the storage gate FET of each of the at least two pixels is higher than a length of the transfer gate FET of each of the at least two pixels.

4. The image sensor of claim 2, wherein the storage gate of each of the at least two pixels has a first terminal coupled to the corresponding photodetector and a second terminal coupled to the corresponding first transfer gate, the first terminal having a higher threshold voltage compared to the second terminal.

5. The image sensor of claim 4, wherein the second terminal has a negative threshold voltage.

6. The image sensor of claim 1, wherein the at least two pixels comprises four pixels arranged in a 2×2 grid.

7. An imaging system comprising the image sensor of claim 1.

8. An image sensor, comprising:
a pixel array having at least one column of addressable pixels, wherein the at least one column of addressable pixels includes at least two pixels with each pixel of the at least two pixels including a photodetector, a storage gate coupled to the photodetector, and a first transfer gate coupled to the storage gate;
a readout circuit including
a second transfer gate having an input coupled to an output of each first transfer gate of each of the at least two pixels, and
a control field effect transistor (FET), wherein a gate of the control FET is configured to receive charge from an output of the second transfer gate.

9. The image sensor of claim 8, wherein the first transfer gate of each of the at least two pixels is a FET and the storage gate of each of the at least two pixels is a FET.

10. The image sensor of claim 9, wherein the length of the storage gate FET of each of the at least two pixels is at least 10 times higher than the length of the transfer gate FET of each of the at least two pixels.

11. The image sensor of claim 9, wherein the storage gate of each of the at least two pixels has a first terminal coupled to the corresponding photodetector and a second terminal coupled to the corresponding first transfer gate, the first terminal having a higher threshold voltage compared to the second terminal.

12. The image sensor of claim 11, wherein the second terminal has a negative threshold voltage.

13. The image sensor of claim 8, further comprising a reset switch coupled to the output of the second transfer gate.

14. A CMOS image sensor (CIS), comprising:
four pixels with each pixel of the four pixels including a photodetector, a storage gate coupled to the photodetector, and a first transfer gate coupled to the storage gate;
a second transfer gate having a single input coupled to an output of each first transfer gate of each of the four pixels; and
a control field effect transistor (FET), wherein a gate of the control FET is configured to receive charge from an output of the second transfer gate.

15. The CIS of claim 14, wherein the first transfer gate of each of the four pixels is a FET and the storage gate of each of the four pixels is a FET.

16. The CIS of claim 15, wherein a length of the storage gate FET of each of the four pixels is higher than a length of the transfer gate FET of each of the four pixels.

17. The CIS of claim 16, wherein the length of the storage gate FET of each of the four pixels is at least 10 times higher than the length of the transfer gate FET of each of the four pixels.

18. The CIS of claim 15, wherein the storage gate of each of the four pixels has a first terminal coupled to the corresponding photodetector and a second terminal coupled to the corresponding first transfer gate, the first terminal having a higher threshold voltage compared to the second terminal.

19. The CIS of claim 18, wherein the second terminal has a negative threshold voltage.

20. The CIS of claim 14, wherein the four pixels are arranged in a 2×2 grid.
